(19) United States
(12) Patent Application Publication
(10) Pub. No.: US 2023/0400296 A1
(43) Pub. Date: Dec. 14, 2023

(54) SCANNING SYSTEMS

(71) Applicant: Hewlett-Packard Development Company, L.P., Spring, TX (US)

(72) Inventors: GUY De WARRENNE BRUCE ADAMS, BRISTOL (GB); STEPHEN POLLARD, BRISTOL (GB); FRASER DICKIN, BRISTOL (GB)

(21) Appl. No.: 18/033,294

(22) PCT Filed: Oct. 23, 2020
(86) PCT No.: PCT/US2020/057057

§ 371 Date: Apr. 21, 2023

(51) Int. Cl. G01B 11/25

(52) U.S. Cl. CPC G01B 11/2518; G01B 11/254

(57) ABSTRACT

In some examples, a scanning system comprises a reference structure comprising multiple fiducial objects arranged within an imaging volume of the scanning system, and a scanner to scan an object on a platform within the imaging volume of the scanning system to generate scan data, the scan data comprising a reference component representing the position of the multiple fiducial objects.

### BACKGROUND

Scanning an object's surface in three dimensions to create digital data, for example to create a digital model of the object, may be helpful when trying to recreate an existing object, or when trying to validate objects created by an additive manufacturing process for example. Various scanning systems can be used to scan objects. The accuracy of such scanners continues to improve, but errors may still be present in scan data.

### BRIEF DESCRIPTION OF THE DRAWINGS

For a more complete understanding of the present disclosure, reference is now made to the following descriptions taken in conjunction with the accompanying drawings, in which:

FIG. 1 is a schematic representation of a scanning system according to an example;

FIG. 2 is a schematic representation of a scanning system according to an example;

FIG. 3 is a flowchart of a method for correcting a scan of an object, according to an example; and

FIG. 4 is a schematic representation of a processor associated with a memory according to an example.

### DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

A scanning system, such as an optical scanning system that uses, e.g., structured light with a projector and either a single mono camera or a pair of stereo cameras to scan an object can be calibrated in order to determine intrinsic and extrinsic parameters that are likely to affect the accuracy of a scan performed by the system. Such calibration can be implemented using a planar calibration target, which can comprise a known pattern. For example, a high contrast (and thus easily detectable) configuration of black dots on a white background or a chequerboard can be used.

A number of images (e.g., 10) of such a calibration target may be captured at different poses (which are defined by respective different angles/distances of an image capture device of the system) within an imaging volume of the system. Differences between measured positions of features of the calibration target and their known positions can be used to determine a system scanning error. The imaging volume represents the region within which an object may be scanned using the system and may generally be related to a field of view of an image capture device of the system at its various possible imaging positions. Thus, for example, an object placed outside of the imaging volume of the system may not be scanned since it is not within the field of view of the image capture device at any of its possible imaging positions.

However, using such a calibration technique results in calibration parameters that may not be able to fully describe the complexity of the optomechanical structure of the system and accordingly the calibration method is not able to reduce reprojection errors to zero.

Furthermore, a scanning system is susceptible to drift from thermo-mechanical effects of, e.g., lenses, baseline distance and so on, which influence the optics/geometry of the system thereby resulting in calibration/performance changes. Thus, calibration using a technique as described above should be repeated regularly in order to maintain best performance.

According to an example, a reference structure comprising multiple fiducial objects arranged within an imaging volume of a scanning system can be used during operation of the system in order to provide data that can be used to improve geometrical accuracy and detect/correct against drift of the system. In an example, the fiducial objects are three-dimensional (3D) objects that are thermo-mechanically stable and for which accurate positions are known.

The use of accurate, persistent fiducial objects acting as reference markers enables scanner drift to be detected and corrected, thereby limiting system warm-up time (during which thermo-mechanical effects come to the fore) and improving robustness to changes in ambient conditions. Furthermore, since changes in pose of a scanning system can introduce small mechanical changes in macro geometry and the micro-structure of the lens systems due to changes stemming from the effect of gravity, the use of such fiducial objects provides additional robustness against these effects.

According to an example, a fiducial object comprises a three-dimensional object. For example, a sphere, such as a precision steel sphere can be used. Alternatively, other shapes can be used, such as dodecahedrons for example. The fiducial object is either inherently optically diffuse (due to its material of composition) or is coated to provide an optically diffuse surface. A fiducial object can be mounted on a support such as a pillar or post for example. Multiple such fiducial objects are provided within the imaging volume of a scanning system, according to an example. The fiducial objects may be arranged at different heights from a platform of the system onto which an object to be scanned may be placed.

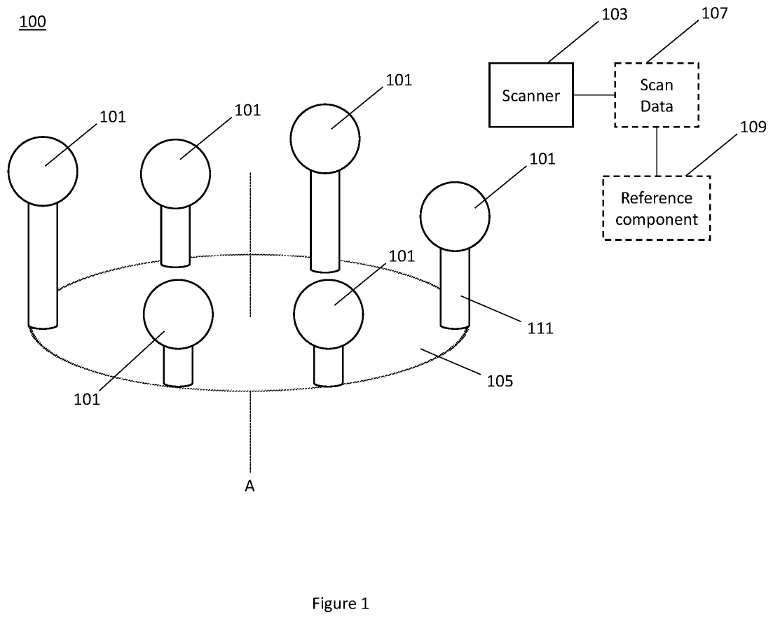

FIG. 1 is a schematic representation of a scanning system according to an example. The scanning system 100 of FIG. 1 comprises a reference structure comprising multiple fiducial objects 101. The reference structure enables a correction of the scanning system 100. The fiducial objects 101 are arranged within an imaging or scan volume of the scanning system 100. In an example, the imaging volume of the system 100 corresponds to the field of view of the scanner 103, or the usable field of view of the scanner, which may include an imaging device such as a camera for example. The imaging volume can be defined as the region outside of which the scanner 103 is either unable to scan an object (i.e. the object is outside of the field of view of the scanner 103), or outside of which the accuracy of the scanner 103 falls below an acceptable level. In the context of FIG. 1 for example, the imaging volume can be considered to be that region within which the scanner 103 is able to image the reference structure and by extension an object on the platform 105 that lies within the reference structure. The scanner 103 is configured to scan an object to be scanned on a platform 105 within the imaging volume of the scanning system 100 to generate scan data 107, the scan data comprising a reference component 109 representing the position of the multiple fiducial objects 101.

The object to be scanned, which is provided on the platform 105 (which object to be scanned may also be termed an item, article or artefact), is distinct from (i.e., not the same as) the fiducial objects 101. That is, the object to be scanned is not a fiducial object. Thus, scan data 107 comprises data representing both an item on the platform that has been scanned as well as data representing the position of the fiducial objects. Put another way, during scanning, an image of the object to be scanned and the fiducial objects is generated.

The scanner 103 can be any suitable scanning device that is able to scan an object to be scanned to create scan data 107 which can be processed to create position data which is indicative of the position of the object relative to the scanner 103. The scanner 103 may be a non-contact scanner, such as an optical, laser or ultrasonic scanner. The scanner can be a 3D structured light scanner comprising a projector and sensors. The sensors detect an illumination pattern projected by the projector on the object. By analysing the distortion of the pattern from a perspective other than that of the projector it is possible to determine, for example via triangulation, information about the position and shape of the object which is illuminated by the projector. In some examples, two sensors (cameras) can be provided. A projector pattern can then be used to help determine correspondences between the two cameras, thereby leading to improved accuracy over systems that use a single camera and a projector (as the intensity profile of the projector may be non-linear and the optics of the projector may be more susceptible to thermal issues). This information can be determined by processing the scan data 107.

Each fiducial object in the example of FIG. 1 is in the form of a sphere atop a support, such as a pillar, rod or post and so on 111 mounted on the platform 105. The platform 105 can rotate around an axis A. Accordingly, an object to be scanned placed (e.g., generally centrally) on the platform 105 can be scanned using the scanner 103 from multiple viewpoints as the platform is 105 is rotated. As is visible from FIG. 1, the height of each of the fiducial objects 101 above the platform 105 varies. Accordingly, as an object on platform 105 is rotated the varying heights of the objects 101 above the platform 105 enables minimal occlusion of an object to be scanned whilst also providing span/coverage of the imaging volume. That is, the accuracy or utility of scan data generated by a scanning system can degrade towards the extremities of the imaging volume of the system. Accordingly, positioning at least some of the fiducial objects around the perimeter of an imaging volume can optimize the error detection.

In some examples, the base 105 and pillars 111 may be composed of a material with a low coefficient of thermal expansion. As such, within a typical environment, temperature variation will not trigger further correction of any reference measurements of the fiducial object locations. A suitable material can be, e.g., Invar (high nickel content iron alloy which has a very low thermal expansion of about 1.2×10⁻⁶ K⁻¹ between 20° C. and 100° C.). Other suitable material with a low coefficient of thermal expansion can be used. For example, Fe-33Ni-4.5Co (Inovco), FeNi42, FeNiCo alloys, and carbon fibre composites comprising, e.g., a carbon foam substructure covered with a carbon fibre/bismaleimide (BMI) prepreg laminate layer.

In the example of FIG. 1, fiducial objects 101 are precision spheres. The fiducial objects can be coated to provide an optically diffuse surface in order to provide diffuse reflection of light, thereby minimising specular reflections that may interfere with the ability of the scanner to image an object for example. In order to achieve a ground truth accuracy for fiducial object measurements to be in the order of, e.g., +/−2-3 um, a coordinate measuring machine (CMM) can be used to initially measure the position fiducial objects in order to provide reference measurements. In an example, the reference frame of the CMM is the CMM. This reference frame can be shifted based on the fiducial objects themselves (e.g., translated to the centre of gravity, or aligned according to a number of chosen spheres). The whole ensemble (e.g., platform and fiducial objects) can then be moved to the imaging volume of the scanner.

In an example, the reference measurements define the position of a fiducial object with respect to a specific point (of a fiducial object). For instance, in the case of a sphere, a reference measurement can define the centre of the sphere. Thus, in this case, a reference measurement defines the position of the centre of the sphere relative to the chosen reference frame.

Thus, accurate reference measurements for the positions of fiducial objects are obtained and for every scan capture of an object using scanner 103, the captured locations of the fiducial objects can be compared to their reference measurements. The comparison may highlight an error (in the form of, e.g., a delta between a measured value and a reference value) and a correction can be computed using the error that can be applied to the scan data 107. In an example, a correction is in the form of a correction matrix that is a non-rigid spatial transformation matrix defining the amount by which a measurement of position of a part of an object that has been scanned can be corrected based on an error derived using the measured value for the position of a fiducial object and its true value as determined using the CMM. Note that the scan data and reference data are initially generated with respect to different reference frames. The non-rigid correction matrix can therefore be determined as that which best maps the scan measurements to the reference measurements.

According to an example, unmodeled or inaccurately modelled calibration parameters can be corrected using a projective correction matrix to map from scanner measured coordinates [x, y, z] to CMM measured coordinates [x″, y″, z″] positions of the fiducial objects. The projective correction matrix can have the form:

$$[ \begin{matrix}{x}^{′} \\ {y}^{′} \\ {z}^{′} \\ {w}^{′}\end{matrix} ] = [ \begin{matrix}a & b & c & d \\ e & f & g & h \\ i & j & k & l \\ m & n & o & 1\end{matrix} ] [ \begin{matrix}x \\ y \\ z \\ 1\end{matrix} ]$$

where final x, y and z values are normalized by w′. That is [x″, y″, z″]=[x′, y′, z′]/w′. A least squares solution to this correction matrix can utilise non-linear minimisation. A similar affine correction matrix where m, n and o are each set to zero can also be considered and solved using linear least squares.

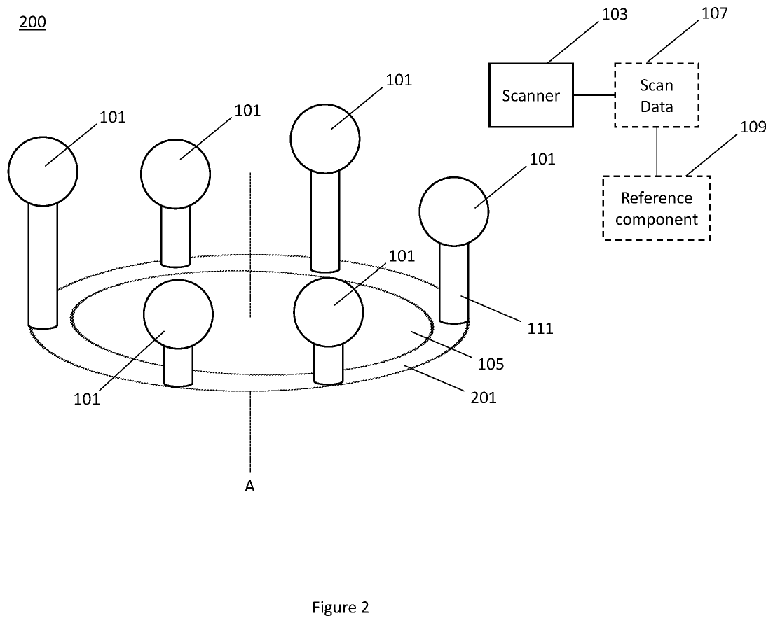

FIG. 2 is a schematic representation of a scanning system according to an example. In the example of FIG. 2, pillars 111 are mounted on a base 201, such as a ring, which is provided outside of the platform 105 or which is physically separated from the platform 105. Thus, the platform 105 can independently rotate in order acquire multiple scans whilst the fiducial objects remain static on the base 201. In some examples, the base 201 may rotate independently of the platform 105, e.g., at the same rate or at different rates. For example, the base 201 can be configured to rotate at a faster or slower rate compared to the rate of rotation of the platform 105. Thus, the platform can move relative to the reference structure comprising the fiducial objects. That is, the reference structure can be fixed. Alternatively, the platform and the reference structure can move relative to the scanner (at the same rate, perhaps independently of one another, or at different rates).

In an example, the structure of the system 200 of FIG. 2 can be configured to enable the base 201 to be fixed to the platform 105, thereby causing them to rotate at the same rate.

For example, an interlocking mechanism, e.g., a lever/pin etc. to connect the base 201 and platform 105, thereby enabling a user to select between fixed and articulated operation of the base 201 can be used. That is, the platform and the reference structure can be releasably coupled to one another.

The base 201 and the platform 105 may be provided in the same plane. Alternatively, the platform 105 may be above the base 201, or vice versa, so that they are vertically offset from one another. Accordingly, it can be possible to select different shapes or profiles for the base 201 and platform 105 given that rotation of the platform 105 does not occur within the base 201 (which therefore dictates that the two are concentric with matching profiles to enable smooth rotation). For example, the base 201 and/or platform 105 may be polygonal.

In an example, fiducial objects can provide differential/augmented correction, e.g., a start position can be used to determine a volume correction (this can then be applied to correct all scans in a cycle) as opposed to per individual scan. Alternatively, the correction can use 3D fiducial data from all the views to improve the accuracy of a correction.

For both examples described with reference to FIG. 1 and FIG. 2, the degree of articulation of the platform 105 (and/or the base 201) may be increased to include pitch and roll.

In an example, fiducial objects 101 may be removable from a pillar 111, which itself may be removable from a base 201 or platform 105. Accordingly, different shaped fiducial objects can be selected and used. Furthermore, the position and height of pillars 111 can be modified.

For example, a platform 105 or base 201 may have multiple suitable points at which a pillar 111 may be affixed using, e.g., a screw threaded protrusion from the base of a pillar that engages into a corresponding portion in the base/platform. Thus, the number, shape, position and height of fiducial objects can be modified as desired.

In some examples, a fiducial object 101 may be mounted or positioned directly on the base 201 or platform 105 without the use of a pillar.

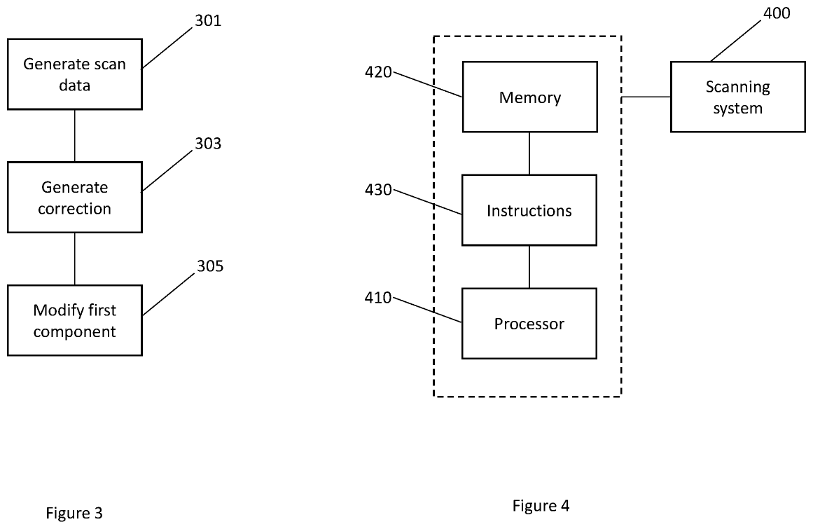

FIG. 3 is a flowchart of a method for correcting a scan of an object, according to an example.

In block 301, scan data 107 of an object to be scanned is generated. The object to be scanned is provided on a platform 105 within an imaging volume of a scanning system 100; 200. Scan data 107 is generated using a scanner 103. The scan data 107 comprises a first component representing a surface structure of a portion of the object, and a second component 109 representing the positions of preselected points of multiple fiducial objects 101 provided within the imaging volume of the scanning system 100; 200. The preselected points representing the captured positions of the fiducial objects can be, e.g., sphere centres in the case that the objects 101 are spheres.

In block 303, the second component 109 of the scan data 107 is used to generate a correction. The correction is derived on the basis of a difference between the positions of the fiducial objects and a set of reference values representing ground measurements of the positions of the preselected points. As described above, the ground measurements can be positions of the fiducial objects (e.g., as defined by their centres) obtained using a CMM.

In block 305, the first component (representing positions for a surface structure of a portion of the object) can be modified using the correction to generate corrected data. In an example, the correction is a correction matrix defining a geometrical transformation matrix as described above, which can be used to adjust the coordinates of a measured position (of a portion of a scanned object) to correct for scanning errors. In an example, the correction factor can be used to update a set of calibration parameters of the scanning system.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

FIG. 4 is a schematic representation of a processor associated with a memory according to an example. In the example of FIG. 4, the memory 420 comprises computer readable instructions 430 which are executable by the processor 410. The instructions 430 can be used to generate image data of an object, item, artefact or article on a platform within a field view of a scanning device of a scanning system 400. The image data can comprise information that defines the position of the article and the position of the fiducial objects. The instructions can further cause the processor to process the image data to determine the positions of multiple fiducial points within the field of view. For example, the image data can be used to determine the position of, e.g. the centre of a fiducial object in the form of a sphere. The instructions 430 can further cause the processor to use the determined positions of the multiple fiducial points to generate a correction factor, such as a correction matrix as described above, and apply the correction factor to an image of the article to generate a corrected article image. That it, the position and/or orientation and/or size of an article determined by the scanning system can be modified by taking into account the measured positions of the fiducial objects compared to reference values for their positions.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The features of any dependent claim may be combined with the features of any of the independent claims or other dependent claims.

1. A scanning system, comprising:
a reference structure comprising multiple fiducial objects arranged within an imaging volume of the scanning system; and
a scanner to scan an object on a platform within the imaging volume of the scanning system to generate scan data, the scan data comprising a reference component representing the position of the multiple fiducial objects.

2. The scanning system as claimed in claim 1, wherein the platform can move relative to the reference structure.

3. The scanning system as claimed in claim 1, wherein the platform and the reference structure can move relative to the scanner.

4. The scanning system as claimed in claim 3, wherein the platform and the reference structure are releasably coupled to one another.

5. The scanning system as claimed in claim 1, wherein each fiducial object is arranged on a support.

6. The scanning system as claimed in claim 1, wherein each fiducial object is a sphere.

7. The scanning system as claimed in claim 1, wherein each fiducial object comprises an optically diffuse surface portion.

8. The scanning system as claimed in claim 1, wherein the fiducial objects are provided at different positions within the imaging volume.

9. The scanning system as claimed in claim 1, wherein the fiducial objects are provided at different heights relative to the platform within the imaging volume.

10. A method for correcting a scan of an object, the method comprising:
generating scan data of an object on a platform within an imaging volume of a scanning system using a scanner, the scan data comprising a first component representing a surface structure of a portion of the object, and a second component representing the positions of preselected points of multiple fiducial objects provided within the imaging volume of the scanning system;
using the second component of the scan data, generating a correction on the basis of a difference between the positions and a set of reference values representing ground measurements of the positions of the preselected points; and
modifying the first component using the correction to generate corrected data.

11. The method as claimed in claim 10, further comprising moving the platform relative to the multiple fiducial objects.

12. The method as claimed in claim 10, further comprising moving the platform and the multiple fiducial objects in unison.

13. The method as claimed in claim 10, further comprising determining the set of reference values using a coordinate measurement apparatus.

14. A non-transitory machine-readable storage medium comprising instructions executable by a processor, the machine-readable storage medium comprising instructions to:
generate image data of an article on a platform within a field view of a scanning device of a scanning system;
process the image data to determine the positions of multiple fiducial points within the field of view;
use the determined positions of the multiple fiducial points to generate a correction factor; and
apply the correction factor to an image of the article to generate a corrected article image.

15. The non-transitory machine-readable storage medium as claimed in claim 14, further comprising instructions to:
use the correction factor to update a set of calibration parameters of the scanning system.
